(19) United States
(12) Patent Application Publication
(10) Pub. No.: US 2026/0230788 A1
(43) Pub. Date: Aug. 6, 2026

(54) COMMUNICATION CONTROL METHOD AND NETWORK APPARATUS

(71) Applicant: KYOCERA Corporation, Kyoto (JP)

(72) Inventor: Mitsutaka HATA, Yokohama-shi (JP)

(73) Assignee: KYOCERA Corporation, Kyoto (JP)

(21) Appl. No.: 19/632,142

(22) Filed: Mar. 27, 2026

Related U.S. Application Data
(63) Continuation of application No. PCT/JP2024/034577, filed on Sep. 27, 2024.

(30) Foreign Application Priority Data
Sep. 28, 2023 (JP) 2023-168503

(51) Int. Cl. H04W 4/90; H04W 24/02

(52) U.S. Cl. CPC H04W 4/90; H04W 24/02

(57) ABSTRACT

In an aspect, a communication control method is a communication control method in a mobile communication system. The communication control method includes transmitting, by a network apparatus to a user equipment, an AI/ML model available under a predetermined condition and deletion prohibition information indicating that the AI/ML model is not allowed to be deleted, before the predetermined condition occurs. The communication control method includes using, by the user equipment, the AI/ML model under the predetermined condition without deleting the AI/ML model according to the deletion prohibition information. Here, the predetermined condition is any of a congestion having occurred on a data communication path of the user equipment, the user equipment transmitting an emergency call, and the user equipment having received a message about a public warning system (PWS).

### RELATED APPLICATIONS

The present application is a continuation based on PCT Application No. PCT/JP2024/034577, filed on Sep. 27, 2024, which claims the benefit of Japanese Patent Application No. 2023-168503 filed on Sep. 28, 2023. The content of which is incorporated by reference herein in their entirety.

### TECHNICAL FIELD

The present disclosure relates to a communication control method and a network apparatus.

### BACKGROUND

In recent years, the Third Generation Partnership Project (3GPP) (trade name), which is a standardization project for mobile communication systems, has studied applying artificial intelligence (AI) technology, particularly, machine learning (ML) technology, to wireless communication (air interface) in the mobile communication systems.

### CITATION LIST

### Non-Patent Literature

Non-Patent Document 1: RP-213599, “New SI: Study on Artificial Intelligence (AI)/Machine Learning (ML) for NR Air Interface”

### SUMMARY

A communication control method according to a first aspect is a communication control method in a mobile communication system. The communication control method includes transmitting, by a network apparatus to a user equipment, an AI/ML model available under a predetermined condition and deletion prohibition information indicating that the AI/ML model is not allowed to be deleted, before the predetermined condition occurs. The communication control method includes using, by the user equipment, the AI/ML model under the predetermined condition without deleting the AI/ML model according to the deletion prohibition information. Here, the predetermined condition is any of congestion having occurred on a data communication path of the user equipment, the user equipment transmitting an emergency call, and the user equipment having received a message about a public warning system (PWS).

A network apparatus according to a second aspect is a network apparatus in a mobile communication system. The network apparatus includes a transmitter configured to transmit to a user equipment an AI/ML model available under a predetermined condition and deletion prohibition information indicating that the AI/ML model is not allowed to be deleted, before the predetermined condition occurs. Here, the predetermined condition is any of congestion having occurred on a data communication path of the user equipment, the user equipment transmitting an emergency call, and the user equipment having received a message about a public warning system (PWS).

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a gNB (base station) according to the first embodiment.

FIG. 4 is a diagram illustrating a configuration example of a protocol stack according to the first embodiment.

FIG. 5 is a diagram illustrating a configuration example of a protocol stack according to the first embodiment.

FIG. 6 is a diagram illustrating a configuration example of functional blocks of an AI/ML technology according to the first embodiment.

FIG. 7 is a diagram illustrating an operation example in an AI/ML technology according to the first embodiment.

FIG. 8 is a diagram illustrating an arrangement example of functional blocks of the AI/ML technology according to the first embodiment.

FIG. 9 is a diagram illustrating an operation example according to a first embodiment.

FIG. 10 is a diagram illustrating an arrangement example of functional blocks of the AI/ML technology according to the first embodiment.

FIG. 11 is a diagram illustrating an arrangement example of functional blocks of the AI/ML technology according to the first embodiment.

FIG. 12 is a diagram illustrating an arrangement example of functional blocks of the AI/ML technology according to the first embodiment.

FIG. 13 is a diagram illustrating an operation example according to the first embodiment.

FIG. 14 is a diagram illustrating an example of a configuration message according to the first embodiment.

FIG. 15 is a diagram illustrating a configuration example of functional blocks of an AI/ML technology according to the first embodiment.

FIG. 16 is a diagram illustrating an example of an operation example according to the first embodiment.

FIG. 17 is a diagram illustrating another operation example according to the first embodiment.

### DESCRIPTION OF EMBODIMENTS

An objective of the present disclosure is to keep user equipment from deleting an AI/ML model.

### First Embodiment

A mobile communication system according to a first embodiment will be described with reference to the drawings. In the description of the drawings, the same or similar parts are denoted by the same or similar reference signs.

### Configuration of Mobile Communication System

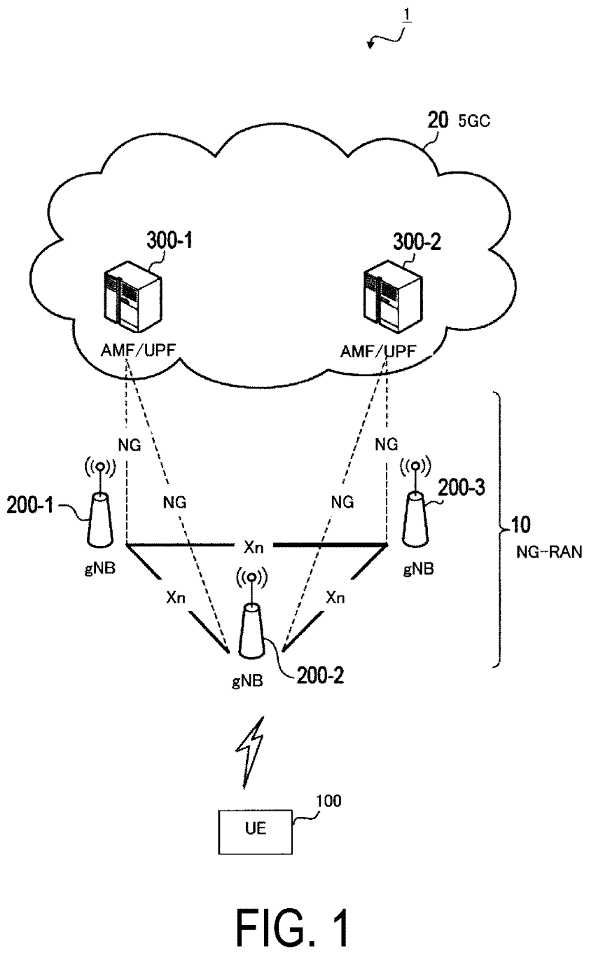

A configuration of a mobile communication system according to a first embodiment will be described. FIG. 1 is a diagram illustrating a configuration example of a mobile communication system 1 according to the first embodiment. The mobile communication system 1 complies with the 5th Generation System (5GS) of the 3GPP standard. 5GS will be hereinafter used as an example, but a Long Term Evolution (LTE) system may be applied at least partially to the mobile communication system. A system of the sixth (6G) or subsequent generation system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 may be hereinafter simply referred to as the RAN 10. The 5GC 20 may be simply referred to as the core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network. The AMF and the UPF 300 may be core network apparatuses included in the CN 20.

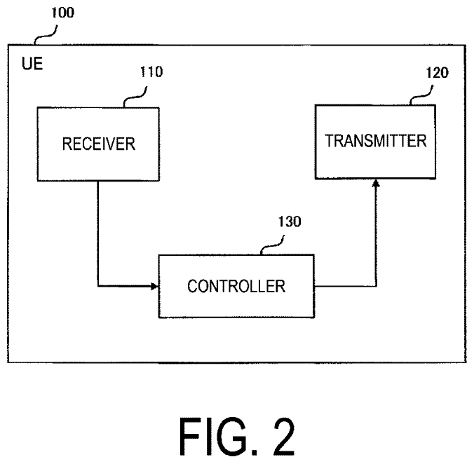

FIG. 2 is a diagram illustrating a configuration example of the UE 100 (user equipment) according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various receptions under the control of the controller 130. The receiver 110 includes an antenna and a receiver. The receiver converts a radio signal or a terahertz wave signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various controls and processes in the UE 100. Such processing includes processing of respective layers to be described later. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that processing or operations performed in the UE 100 may be performed in the controller 130.

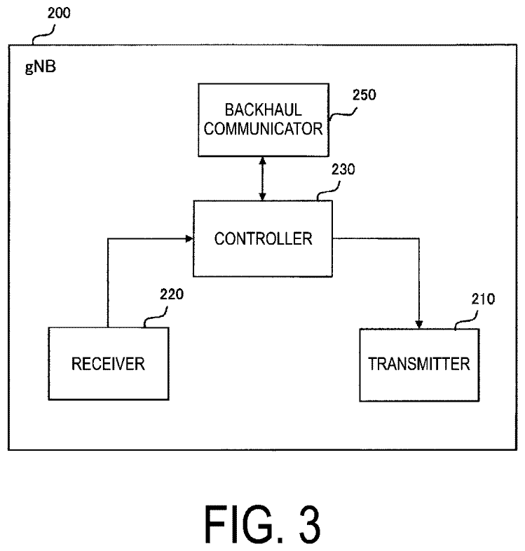

FIG. 3 is a diagram illustrating a configuration example of the gNB 200 (base station) according to the first embodiment. The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various transmissions under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna.

The receiver 220 performs various types of reception under control of the controller 230. The receiver 220 includes an antenna and a reception device. The receiver converts a radio signal or a terahertz wave signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing performed in the gNB 200 may be performed by the controller 230.

The backhaul communicator 250 is connected to a neighboring base station via an Xn interface which is an inter-base station interface. The backhaul communicator 250 is connected to the AMF/UPF 300 via an NG interface being an interface between a base station and the core network. Note that the gNB 200 may include a central unit (CU) and a distributed unit (DU) (i.e., functions are divided), and the two units may be connected via an F1 interface, which is a fronthaul interface.

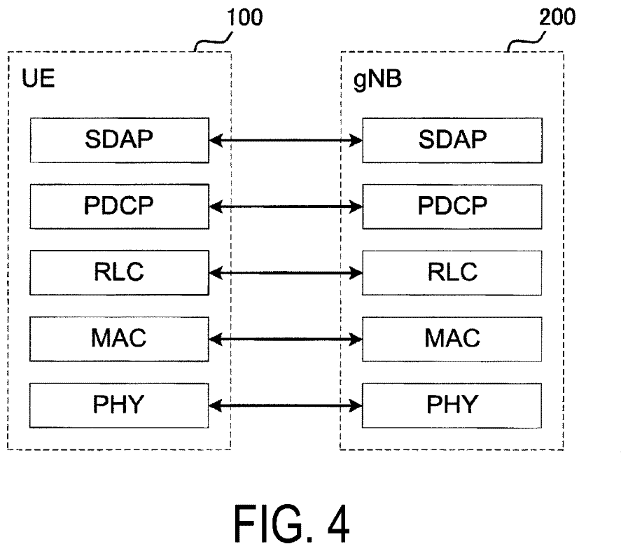

FIG. 4 is a diagram illustrating a configuration example of a protocol stack of a user plane radio interface that handles data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. The DCI transmitted from the gNB 200 is appended with Cyclic Redundancy Code (CRC) parity bits scrambled by the RNTI.

In NR, the UE 100 can use a bandwidth narrower than a system bandwidth (i.e., a cell bandwidth). The gNB 200 configures a bandwidth portion (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for Quality of Service (QoS) control by the core network, and radio bearers, which are units for QoS control by the Access Stratum (AS). Note that, when the RAN is connected to the EPC, the SDAP need not be provided.

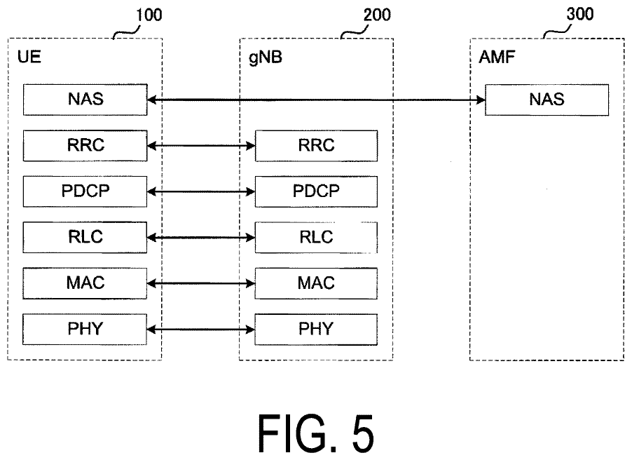

FIG. 5 is a diagram illustrating a configuration of a protocol stack of a radio interface of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300. The UE 100 includes an application layer other than the protocol of the radio interface. A layer lower than the NAS is referred to as an Access Stratum (AS).

### AI/ML Technology

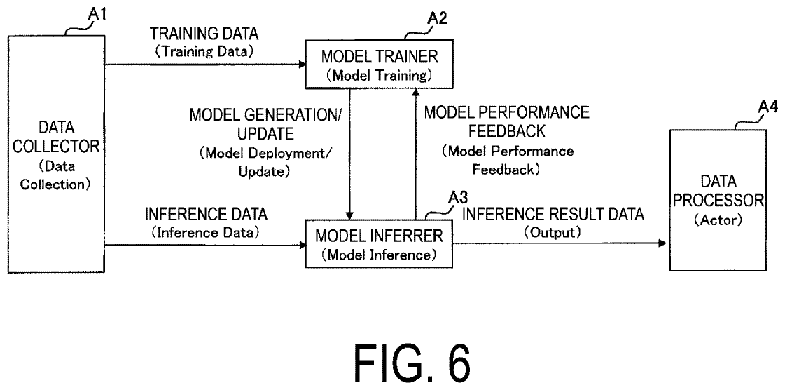

In the embodiment, an AI/ML Technology will be described. FIG. 6 is a diagram illustrating a configuration example of functional blocks of the AI/ML technology in the mobile communication system 1 according to the first embodiment.

The functional block configuration example illustrated in FIG. 6 includes a data collector A1, a model trainer A2, a model inferrer A3, and a data processor A4.

The data collector A1 collects input data, specifically, training data and inference data. The data collector A1 outputs the training data to the model trainer A2. The data collector A1 also outputs the inference data to the model inferrer A3. The data collector A1 may acquire data in the apparatus in which the data collector A1 is provided, as input data. The data collector A1 may acquire, as the input data, data in another apparatus. Data collection refers to the process of collecting data at a network node, a management entity, or the UE 100, for example, to train AI/ML models, perform data analysis, and inference. Based on the data collected by the data collector A1, the training of the AI/ML model and the inference of the AI/ML model in the subsequent stage are performed. The “AI/ML model” is, for example, a data-driven algorithm to which an AI/ML technology is applied to generate a series of outputs based on a series of inputs. Hereinafter, the “model” and the “AI/ML model” may be used interchangeably.

The model trainer A2 performs model training. Specifically, the model trainer A2 optimizes parameters of the training model through machine learning using the training data, and derives (or generates, or updates) the trained model. The model trainer A2 outputs the derived trained model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. Supervised learning is a method of using correct answer data for the training data. Unsupervised learning is a method of not using correct answer data for the training data. For example, in unsupervised learning, feature points are learned from a large amount of training data, and correct answer determination (range estimation) is performed. The reinforcement learning is a method of assigning a score to an output result and learning a method of maximizing the score. Although the supervised learning will be described hereinafter, unsupervised learning may be applied as the machine learning. The reinforcement learning may be applied as the machine learning. In this way, the process of training an AI/ML model (by training the relationship between input and output) in a data-driven manner and acquiring a trained AI/ML model is called, for example, AI/ML model training. Hereinafter, the “AI/ML model training” may be referred to as a “model training”. The trained AI/ML model may be referred to as a “trained model”.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. The model has various approaches, such as linear regression analysis, neural network, and decision tree analysis. The above “y=ax+b” can be considered as a kind of the linear regression analysis. The model inferrer A3 may perform model performance feedback to the model trainer A2. This process of using a trained AI/ML model to generate a series of outputs based on a series of inputs is called AI/ML model inference. Hereinafter, the “AI/ML model inference” may be referred to as “model inference”.

The data processor A4 receives the inference result data and performs processing that utilizes the inference result data.

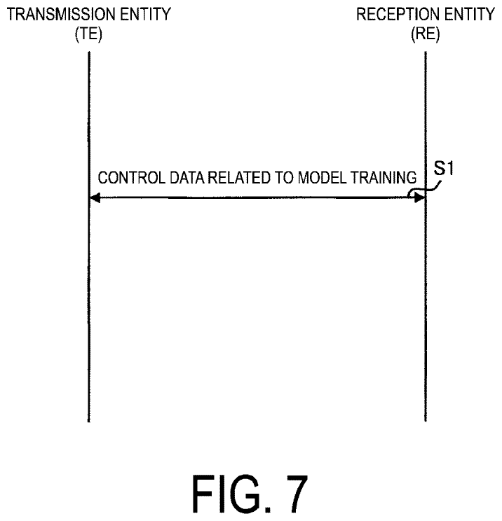

FIG. 7 is a diagram illustrating an operation example in the AI/ML technology according to the first embodiment.

A transmission entity TE is, for example, an entity in which machine learning is performed. The transmission entity TE may derive a trained model by performing machine learning. The transmission entity TE uses the trained model to generate inference result data as an inference result. The transmission entity TE can transmit the inference result data to a reception entity RE.

The reception entity RE is, for example, an entity in which no machine learning is performed. The reception entity RE can receive the inference result data transmitted from the transmission entity TE. The reception entity RE performs various processing operations by using the inference result data. The reception entity RE may derive a trained model by performing machine learning. In this case, the reception entity RE transmits the derived trained model to the transmission entity TE.

Note that the entity may be, for example, a device. The entity may be a functional block included in the device. The entity may be, for example, a hardware block included in the device.

For example, the transmission entity TE may be the UE 100, and the reception entity RE may be the gNB 200 or a core network apparatus. Alternatively, the transmission entity TE may be the gNB 200 or a core network apparatus, and the reception entity RE may be the UE 100.

As illustrated in FIG. 7, in step S1, the transmission entity TE transmits to and receives from the reception entity RE control data related to the AI/ML technology. The control data may be an RRC message that is RRC layer (i.e., layer 3) signaling. The control data may be a MAC Control Element (CE) that is MAC layer (i.e., layer 2) signaling. The control data may be Downlink Control Information (DCI) that is PHY layer (i.e., layer 1) signaling. The downlink signaling may be UE-specific signaling. The downlink signaling may be broadcast signaling. The control data may be a control message in a control layer (e.g., an AI/ML layer) dedicated to artificial intelligence or machine learning.

### Arrangement Examples and Use Cases

How the functional blocks illustrated in FIG. 6 are arranged in the mobile communication system 1 will be described. Hereinafter, arrangement examples of the functional blocks will be described along specific use cases.

Use cases applied in the AI/ML technology include, for example, the following three cases.
(1.1) “Channel State Information (CSI) feedback enhancement”
(1.2) “Beam management”
(1.3) “Positioning accuracy enhancement”

Hereinafter, an arrangement example of the functional blocks will be described for each use case.

### (1.1) Arrangement Example of Functional Blocks in “CSI Feedback Enhancement”

The “CSI feedback enhancement” represents, for example, a use case where the machine learning technology is applied to the CSI fed back from the UE 100 to the gNB 200. The CSI is information related to a downlink channel state between the UE 100 and the gNB 200. The CSI includes at least one selected from the group consisting of a Channel Quality Indicator (CQI), a Precoding Matrix Indicator (PMI), and a Rank Indicator (RI). The gNB 200 performs, for example, downlink scheduling based on the CSI feedback from the UE 100.

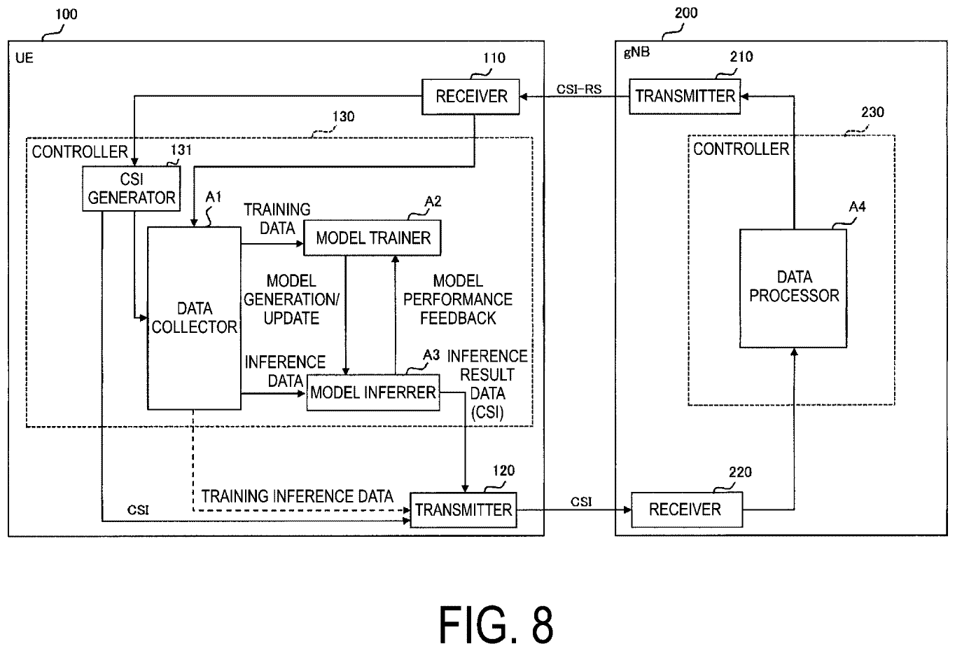

FIG. 8 is a diagram illustrating an arrangement example of the functional blocks in the “CSI feedback enhancement”. In the example of “CSI feedback enhancement” illustrated in FIG. 8, the controller 130 of the UE 100 includes the data collector A1, the model trainer A2, and the model inferrer A3. On the other hand, the controller 230 of the gNB 200 includes the data processor A4. In other words, the UE 100 performs model training and model inference. FIG. 8 illustrates an example in which the transmission entity TE is the UE 100 and the reception entity RE is the gNB 200.

In the “CSI feedback enhancement”, the gNB 200 transmits a reference signal for the UE 100 to estimate the downlink channel state. The reference signal will be described below taking a CSI reference signal (CSI-RS) as an example, but may be a demodulation reference signal (DMRS).

First, in the model training, the UE 100 (receiver 110) receives a first reference signal from the gNB 200 by using first resources. Then, the UE 100 (model trainer A2) derives a trained model for inferring CSI from the reference signal by using training data including the first reference signal and CSI. Such a first reference signal may be referred to as a full CSI-RS.

For example, a CSI generator 131 performs channel estimation by using the reception signal (CSI-RS) received by the receiver 110, and generates CSI. The transmitter 120 transmits the generated CSI to the gNB 200. The model trainer A2 performs model training by using a set of the reception signal (CSI-RS) and the CSI as the training data to derive a trained model for inferring the CSI from the reception signal (CSI-RS).

Second, in the model inference, the receiver 110 receives a second reference signal from the gNB 200 by using second resources the amount of which is smaller than that of the first resources. Then, the model inferrer A3 uses the trained model to infer the CSI as inference result data using the second reference signal as inference data. Such a second reference signal may hereinafter be referred to as a partial CSI-RS or a punctured CSI-RS.

For example, the model inferrer A3 causes the partial CSI-RS received by the receiver 110 to be input to the trained model as the inference data, and infers the CSI from the CSI-RS. The transmitter 120 transmits the inferred CSI to the gNB 200.

This enables the UE 100 to feed back (or transmit), to the gNB 200, accurate (complete) CSI from the fewer CSI-RSs (partial CSI-RS) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

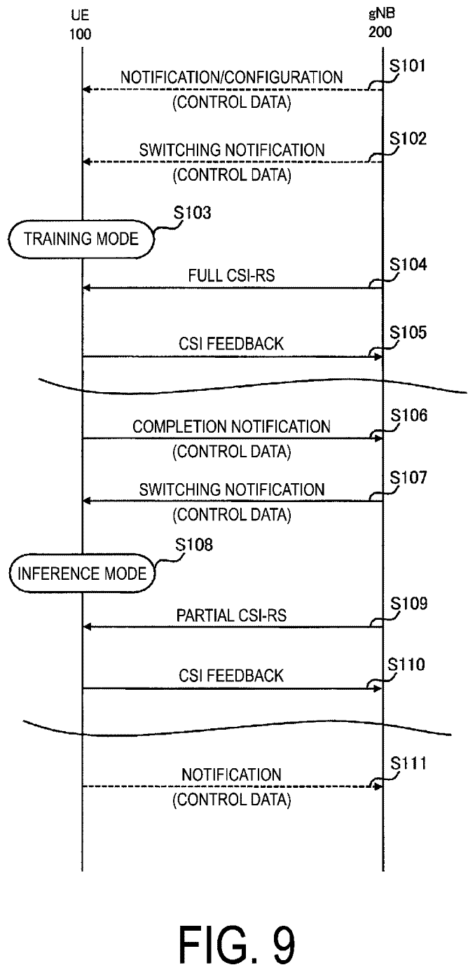

FIG. 9 is a diagram illustrating an operation example in the “CSI feedback enhancement” according to the first embodiment.

As illustrated in FIG. 9, in step S101, the gNB 200 may notify the UE 100 of or configure for the UE 100, as the control data, a transmission pattern (punctured pattern) of the CSI-RS in the inference mode. For example, the gNB 200 transmits, to the UE 100, antenna ports and/or time-frequency resources used or not used to transmit the CSI-RS in the inference mode.

In step S102, the gNB 200 may transmit, to the UE 100, a switching notification for causing the UE 100 to start the training mode.

In step S103, the UE 100 starts the training mode.

In step S104, the gNB 200 transmits a full CSI-RS. The receiver 110 of the UE 100 receives the full CSI-RS, and the CSI generator 131 generates (estimates) CSI based on the full CSI-RS. In the training mode, the data collector A1 collects the full CSI-RS and the CSI. The model trainer A2 uses the full CSI-RS and the CSI as training data to generate a trained model.

In step S105, the UE 100 transmits the generated CSI to the gNB 200.

Thereafter, in step S106, when the model training is completed, the UE 100 transmits, to the gNB 200, a completion notification indicating that the model training is completed. The UE 100 may transmit the completion notification when creation of the trained model is completed.

In step S107, in response to receiving the completion notification, the gNB 200 transmits, to the UE 100, a switching notification for switching the UE 100 from the training mode to the inference mode.

In step S108, in response to receiving the switching notification, the UE 100 switches from the training mode to the inference mode.

In step S109, the gNB 200 transmits a partial CSI-RS. The receiver 110 of the UE 100 receives the partial CSI-RS. In the inference mode, the data collector A1 collects the partial CSI-RS. The model inferrer A3 causes the partial CSI-RS to be input to the trained model as inference data, and obtains CSI as an inference result.

In step S110, the UE 100 transmits (or feeds back), to the gNB 200 as inference result data, the CSI, which is an inference result. The UE 100 can generate a trained model with a predetermined accuracy or higher by repeating model training in the training mode. The inference result obtained by using the trained model generated as described above is expected to have a predetermined accuracy or higher.

Note that, in step S111, upon determining that the model training is necessary, the UE 100 may transmit a notification as the control data to the gNB 200, the notification indicating that the model training is necessary.

In the example illustrated in FIG. 9, an example in which the training data is “(full) CSI-RS” and “CSI”, and the inference data is “(partial) CSI-RS” has been described. Hereinafter, the training data and/or the inference data may be referred to as a “dataset”.

In the “CSI feedback enhancement”, in addition to the “CSI-RS” and the “CSI”, for example, the following data and/or information may be used as the dataset.
(X1) Reference Signals Received Power (RSRP), Reference Signal Received Quality (RSRQ), Signal-to-interference-plus-noise ratio (SINR), or an output waveform of an AD converter (a measurement target of these data may be the CSI-RS. The measurement target may be other reception signals received from the gNB 200)
(X2) Bit Error Rate (BER) or Block Error Rate (BLER) ((BER (or BLER) may be measured based on CSI-RS with a total number of transmission bits (or a total number of transmission blocks) being known)
(X3) Moving speed of the UE 100 (which may be measured by a speed sensor in the UE 100)

What is used as a dataset used for machine learning may be configured. For example, the following processing may be performed. In other words, the UE 100 transmits capability information as the control data to the gNB 200, the capability information indicating which type of input data the UE 100 can handle in the machine learning. The capability information may represent, for example, any of the data or information indicated in (X1) to (X3). The capability information may be information in which training data and inference data are separately designated. The gNB 200 transmits, to the UE 100 as the control data, the data type information used as a dataset. The data type information may represent, for example, any one of data or information indicated in (X1) to (X3). As the data type information, data type information used as training data and data type information used as inference data may be separately designated.

### (1.2) Arrangement Example of Functional Blocks in “Beam Management”

An arrangement example of the functional blocks in the “beam management” will be described. The “beam management” represents, for example, a use case where the machine learning technology is used to manage which beam is an optimum beam among the beams transmitted from the gNB 200.

In the “beam management”, the gNB 200 sequentially transmits beams having different directivities. Each beam includes, for example, a reference signal. The UE 100 measures the reception quality of each beam using the reference signal included in the beam. The UE 100 determines, for example, a beam with the best reception quality as the optimum beam.

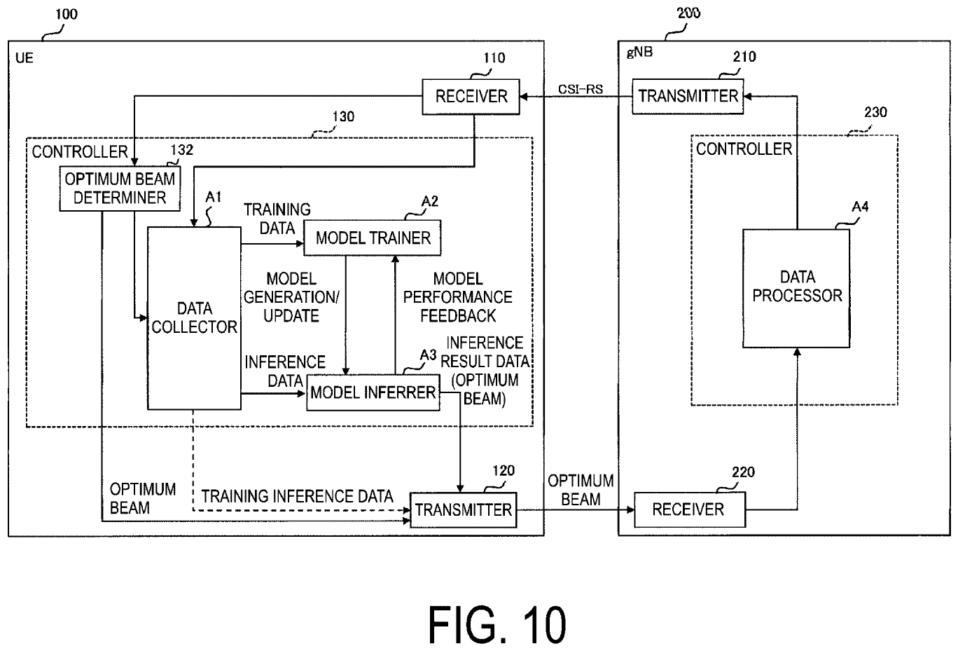

FIG. 10 is a diagram illustrating an arrangement example of each of the functional blocks in the “beam management”. In the example of the “beam management” illustrated in FIG. 10, the controller 130 of the UE 100 includes the data collector A1, the model trainer A2, and the model inferrer A3. On the other hand, the controller 230 of the gNB 200 includes the data processor A4. In other words, FIG. 10 illustrates an example in which the UE 100 performs model training and model inference. FIG. 10 illustrates the example in which the transmission entity TE is the UE 100 and the reception entity RE is the gNB 200.

As illustrated in FIG. 10, the UE 100 includes an optimum beam determiner 132. The optimum beam determiner 132 determines the optimum beam based on, for example, the reception quality of the reference signal included in each beam. As with “CSI feedback”, an example in which a CSI-RS is used as the reference signal will be described, but a demodulation reference signal (DMRS) may be used as the reference signal. The transmitter 120 transmits information representing the determined optimum beam to the gNB 200 as the “optimum beam”.

An operation example in the “beam management” can be implemented by replacing the “CSI feedback” with the “optimum beam” in FIG. 9.

In the training mode (step S103), the gNB 200 sequentially transmits, to the UE 100, beams having different directivities (step S104). Each beam includes the full CSI-RS. In the training mode, the data collector A1 of the UE 100 collects the full CSI-RS and the optimum beam (information indicating the optimum beam). The model trainer A2 generates a trained model using the CSI-RS and the optimum beam (information indicating the optimum beam) as training data. The full CSI-RS is an example of the first reference signal, and the partial CSI-RS is an example of the second reference signal.

In the inference mode (step S108), the gNB 200 sequentially transmits beams having different directivities. Each beam includes a partial CSI-RS. In the inference mode, the data collector A1 collects the partial CSI-RS. The model inferrer A3 causes the partial CSI-RS to be input to the trained model as inference data, and obtains the optimum beam (information indicating the optimum beam) as an inference result. The UE 100 transmits the inference result (optimum beam) to the gNB 200 as inference result data.

In the “beam management”, in addition to the “CSI-RS” and the “optimum beam”, for example, the following data and/or information may be used as the data used for the dataset.
(Y1) Synchronization Signal Block (SSB) received from the gNB 200
(Y2) RSRP, RSRQ, SINR, or the output waveform of the AD converter (a measurement target thereof may be the CSI-RS. The measurement target may be other reception signals received from the gNB 200)
(Y3) BER or BLER (BER (or BLER) may be measured based on the CSI-RS with the total number of transmission bits (or the total number of transmission blocks) known)
(Y4) Number of beams or a beam pattern
(Y5) Measurement value of a beam (including multiple values)
(Y6) Moving speed of the UE 100 (which may be measured by the speed sensor in the UE 100)

The UE 100 may transmit capability information as the control data to the gNB 200, the capability information indicating which type of input data the UE 100 can handle in the machine learning. The capability information may include any information or data from among (Y1) to (Y6). Aside from the training data and the inference data, the capability information may include any information or data from among (Y1) to (Y6). The gNB 200 may transmit, to the UE 100 as the control data, the data type information used as a dataset. The data type information may include, for example, any of the data or information indicated in (Y1) to (Y6). Aside from the training data and the inference data, the data type information may include any information or data from among (Y1) to (Y6).

### (1.3) Arrangement Example of Functional Blocks in “Positioning Accuracy Enhancement”

An arrangement example of the functional blocks in the “positioning accuracy enhancement” will be described. The “positioning accuracy enhancement” represents, for example, a use case where the accuracy of the position information measured by the UE 100 is enhanced using the machine learning technology.

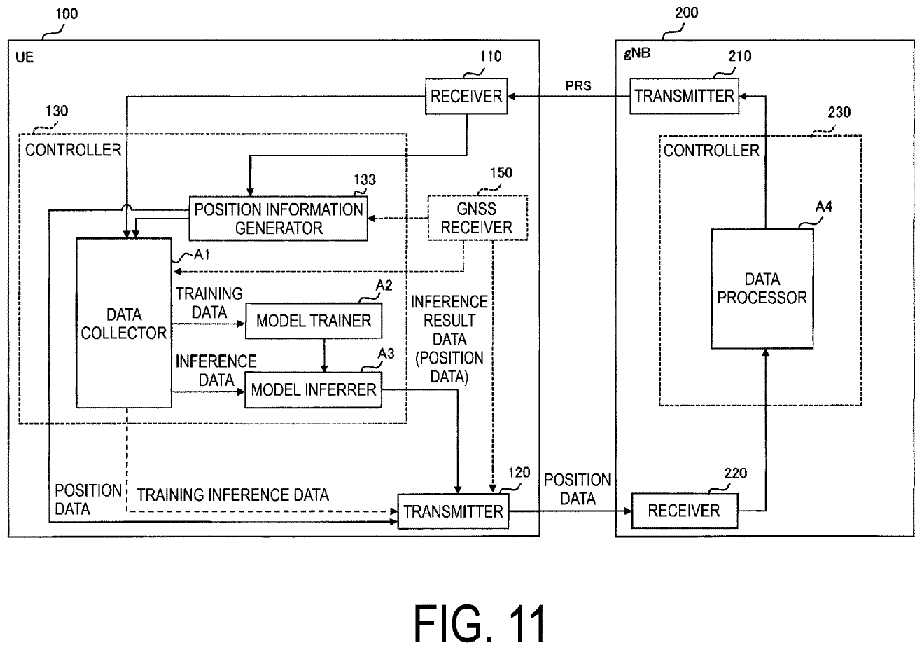

FIG. 11 is a diagram illustrating an arrangement example of each of the functional blocks in the “positioning accuracy enhancement”. In the example of the “positioning accuracy enhancement” illustrated in FIG. 11, the controller 130 of the UE 100 includes the data collector A1, the model trainer A2, and the model inferrer A3. On the other hand, the controller 230 of the gNB 200 includes the data processor A4. In other words, FIG. 11 illustrates an example in which the UE 100 performs model training and model inference. FIG. 11 illustrates the example in which the transmission entity TE is the UE 100 and the reception entity RE is the gNB 200.

As illustrated in FIG. 11, the UE 100 includes a position information generator 133. The UE 100 may include a Global Navigation Satellite System (GNSS) receiver 150. The position information generator 133 generates position data of the UE 100 based on a Positioning Reference Signal (PRS) (full PRS or partial PRS) received from the gNB 200. The position information generator 133 may receive a GNSS signal (full GNSS signal or partial GNSS signal) received by the GNSS receiver 150 and generate the position data of the UE 100 based on the GNSS signal.

Note that, as with the full CSI-RS, the gNB 200 transmits the full PRS using a predetermined amount of first resources (for example, all antenna ports or a predetermined amount of time frequency resources). As with the partial CSI-RS, the gNB 200 transmits the partial PRS by using the second resources (for example, half the antenna ports in the antenna panel, or half the predetermined amount of time-frequency resources) in a smaller amount than the first resources.

The full GNSS signal may be a GNSS signal temporally continuously received by the GNSS receiver 150. The partial GNSS signal may be a GNSS signal intermittently received by the GNSS receiver 150. In other words, a predetermined amount of first resources may be used for the full GNSS signal, and the second resources the amount of which is smaller than that of the first resources may be used for the partial GNSS signal.

An operation example in the “positioning accuracy enhancement” can be implemented by replacing the “full CSI-RS” with the “full PRS”, the “partial CSI-RS” with the “partial PRS”, and the “CSI feedback” with the “position data” in FIG. 9.

In the training mode (step S103), the position information generator 133 generates the position data of the UE 100 based on the full PRS received from the gNB 200. The position information generator 133 may receive a full GNSS signal received by the GNSS receiver 150 and generate the position data of the UE 100 based on the full GNSS signal. The transmitter 120 feeds back (or transmits) the position data to the gNB 200. The data collector A1 collects the full PRS (or the full GNSS signal) and the position data. The model trainer A2 generates a trained model using the full PRS (or the full GNSS signal) and the position data as training data.

In the inference mode (step S108), the data collector A1 collects the partial PRS received by the receiver 110 (or the partial GNSS signal received by the GNSS receiver 150). The model inferrer A3 causes the partial PRS (or the partial GNSS signal) and the position data to be input to the trained model as inference data, and obtains the position data as an inference result. The UE 100 transmits the inference result (position data) to the gNB 200 as inference result data.

In the “positioning accuracy enhancement”, in addition to the “PRS”, the “GNSS signal”, and the “position data”, for example, the following data and/or information may be used as the data used for the dataset.
(Z1) RSRP, RSRQ, Signal-to-interference-plus-noise ratio (SINR), or the output waveform of the AD converter (a measurement target of these data may be the PRS. The measurement target may be other reception signals received from the gNB 200)
(Z2) Line Of Sight (LOS) or Non Line Of Sight (NLOS)
(Z3) Measurement timing, accuracy, likelihood
(Z4) RF fingerprint (cell ID and reception quality in the cell having the cell ID)
(Z5) Angle of Arrival (AOA) of a reception signal, a reception level for each antenna, a reception phase for each antenna, and an Observed Time Difference Of Arrival (OTDOA) for each antenna
(Z6) Reception information of a beacon used in short-range wireless communication such as wireless Local Area Network (LAN) such as Wi-Fi (trade name), or Bluetooth (trade name)
(Z7) Moving speed of the UE 100 (the moving speed may be measured by the GNSS receiver 150. The moving speed may be measured by a speed sensor in the UE 100)

The UE 100 may transmit capability information as the control data to the gNB 200, the capability information indicating which type of input data the UE 100 can handle in the machine learning. The capability information may include any information or data from among (Z1) to (Z7). Aside from the training data and the inference data, the capability information may include any information or data from among (Z1) to (Z7). The gNB 200 may transmit, to the UE 100 as the control data, the data type information used as a dataset. The data type information may include, for example, any of the data or information indicated in (Z1) to (Z7). Aside from the training data and the inference data, the data type information may include any information or data from among (Z1) to (Z7).

### (1.4) Other Arrangement Examples

Other arrangement examples will be described.

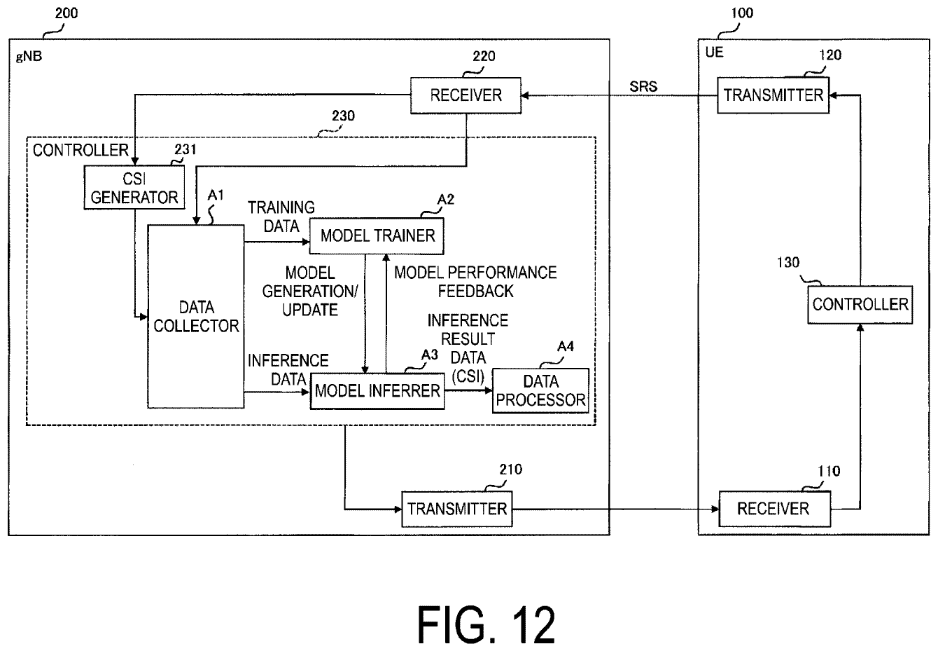

FIG. 12 is a diagram illustrating another arrangement example of the “CSI feedback enhancement” according to the first embodiment. FIG. 12 illustrates an example in which the gNB 200 includes the data collector A1, the model trainer A2, the model inferrer A3, and the data processor A4. In other words, FIG. 12 illustrates an example in which the gNB 200 performs model training and model inference. FIG. 12 illustrates an example in which the transmission entity TE is the gNB 200 and the reception entity RE is the UE 100.

FIG. 12 illustrates an example in which the AI/ML technology is introduced into CSI estimation performed by the gNB 200 based on a Sounding Reference Signal (SRS). Thus, the gNB 200 includes a CSI generator 231 that generates CSI based on the SRS. The CSI is information indicating an uplink channel state between the UE 100 and the gNB 200. The gNB 200 (e.g., the data processor A4) performs, for example, uplink scheduling based on the CSI generated based on the SRS.

### (1.5) Model Transfer Example

In (1.1) to (1.4), the arrangement example of the functional blocks of the AI/ML technology has been described. Model transfer will be described below. The model to be transferred may be a trained model used in the model inference. The model may be an untrained model used in the model training (or a model being trained).

### (1.5.1) First Operation Pattern Relating to Model Transfer

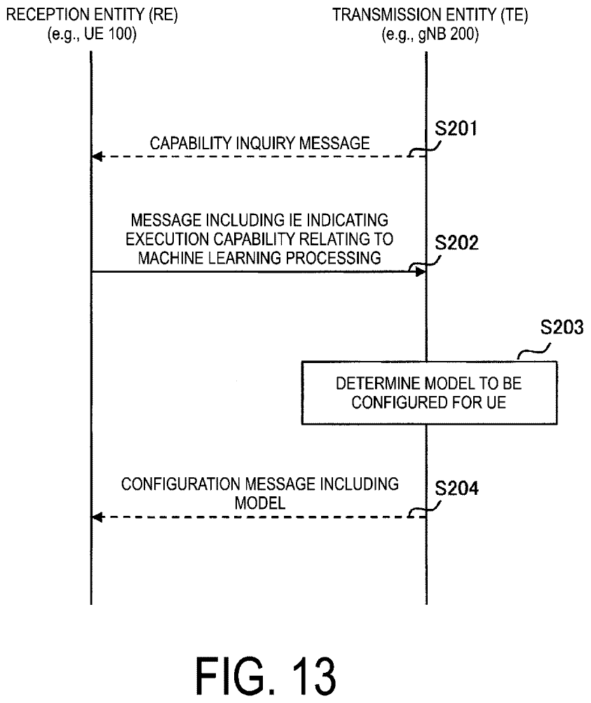

FIG. 13 is a diagram illustrating an operation example of a first operation pattern relating to model transfer according to the first embodiment. In the example illustrated in FIG. 13, the reception entity RE is mainly described as the UE 100. However, the reception entity RE may be the gNB 200 or the AMF 300. In the example illustrated in FIG. 13, the transmission entity TE is mainly described as the gNB 200. However, the transmission entity TE may be the UE 100 or the AMF 300.

As illustrated in FIG. 13, in step S201, the gNB 200 transmits, to the UE 100, a capability inquiry message for requesting transmission of a message including an information element (IE) indicating the execution capability relating to machine learning processing. The UE 100 receives the capability inquiry message. However, the gNB 200 may transmit the capability inquiry message when performing the machine learning processing (when determining to perform the machine learning process).

In step S202, the UE 100 transmits, to the gNB 200, the message including an information element indicating an execution capability relating to the machine learning processing (an execution environment for the machine learning processing, from another viewpoint). The gNB 200 receives the message. The message may be an RRC message, for example, a “UE Capability” message or a newly defined message (e.g., a “UE AI Capability” message or the like). Alternatively, the transmission entity TE may be the AMF 300 and the message may be a NAS message. Alternatively, when a new layer for performing or controlling the machine learning processing (AI/ML processing) is defined, the message may be a message of the new layer.

The information element indicating the execution capability relating to the machine learning processing may be an information element indicating capability of a processor for performing the machine learning processing and/or an information element indicating capability of a memory for performing the machine learning processing. Specifically, the information element indicating the capability of the processor may be an information element indicating a product number (or model number) of an AI processor. Specifically, the information element indicating the capability of the memory may be an information element indicating the memory capacity.

Alternatively, the information element indicating the execution capability relating to the machine learning processing may be an information element indicating the execution capability of the inference processing (model inference). The information element indicating the execution capability of the inference processing may be, specifically, an information element indicating whether a deep neural network model can be supported or an information element indicating a time (or a response time) required for execution of the inference processing.

Alternatively, the information element indicating the execution capability relating to the machine learning processing may be an information element indicating the execution capability of the learning processing (model training). The information element indicating the execution capability of the learning processing may be specifically an information element indicating the number of simultaneous executions of the learning processing or an information element indicating a processing capacity of the learning processing.

In step S203, the gNB 200 determines a model to be configured (deployed) for the UE 100 based on the information element included in the message received in step S202.

In step S204, the gNB 200 transmits, to the UE 100, a message including the model determined in step S203. The UE 100 receives the message and performs the machine learning processing (i.e., model training processing and/or model inference processing) using the model included in the message. A specific example of step S204 will be described next in a second operation pattern.

### (1.5.2) Second Operation Pattern Relating to Model Transfer

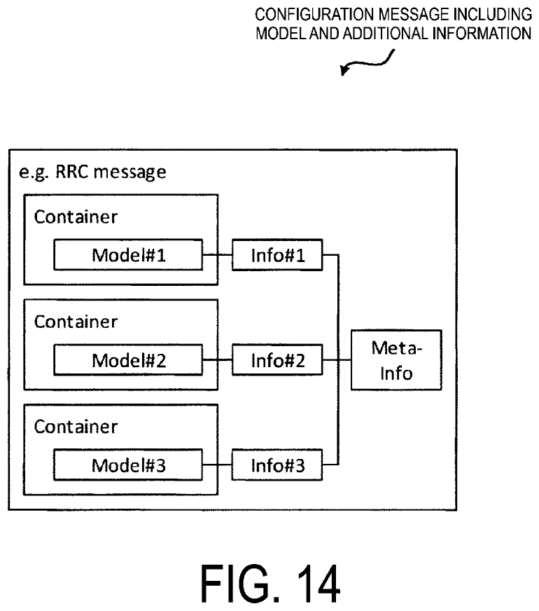

FIG. 14 is a diagram illustrating an example of a configuration message including models and additional information according to the first embodiment. The configuration message may be an RRC message transmitted from the gNB 200 to the UE 100 (for example, an “RRC Reconfiguration” message, or a newly defined message (for example, an “AI Deployment” message, an “AI Reconfiguration” message, or the like)). Alternatively, the configuration message may be a NAS message transmitted from the AMF 300 to the UE 100. Alternatively, when a new layer for performing or controlling the machine learning processing (AI/ML processing) is defined, the message may be a message of the new layer.

In the example of FIG. 14, the configuration message includes three models (Model #1 to Model #3). Each model is included as a container of the configuration message. However, the configuration message may include only one model. The configuration message further includes, as the additional information, three pieces of individual additional information (Info #1 to Info #3) individually provided corresponding to three models (Model #1 to Model #3), respectively, and common additional information (Meta-Info) commonly associated with three models (Model #1 to Model #3). Each piece of individual additional information (Info #1 to Info #3) includes information unique to the corresponding model. The common additional information (Meta-Info) includes information common to all models in the configuration message.

The individual additional information may be a model index representing an index (index number) assigned to each model. The individual additional information may be a model execution condition indicating performance (for example, processing delay) required for applying (executing) the model.

The individual additional information or the common additional information may be a model application designating a function to which the model is applied (for example, “CSI feedback”, “beam management”, “position measurement”, or the like). The individual additional information or the common additional information may be a model selection criterion for applying (executing) a corresponding model in response to satisfaction of a designated criterion (for example, a moving speed).

### (1.6) Configuration Example of Functional Blocks

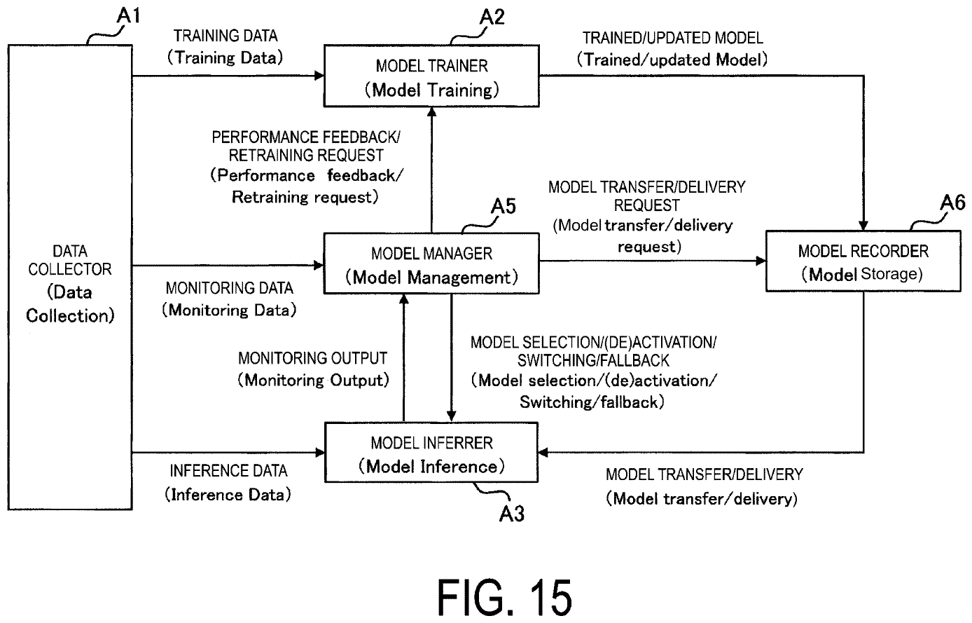

The functional blocks of the AI for wireless communication have been described with reference to FIG. 6. Currently, the 3GPP has studied a block diagram illustrated in FIG. 15 for functional blocks of AI for wireless communication.

FIG. 15 is a diagram illustrating a configuration example of functional blocks according to the first embodiment. The functional block diagram illustrated in FIG. 15 further includes a model manager A5 and a model recorder A6, as compared with the functional block diagram illustrated in FIG. 6.

The model manager A5 manages the AI/ML model. For example, the model manager A5 requests the model trainer A2 to re-train the training model, or requests the model recorder A6 to transfer the model. As illustrated in FIG. 15, the AI/ML model that has been trained in the re-training may be referred to as an updated model. For example, the model manager A5 instructs (or requests) the model inferrer A3 to select a model, (de)activate a model, switch a model, and/or fall back. The model manager A5 may evaluate the performance of the trained models using the monitoring data acquired from the data collector A1 and the monitoring output acquired from the model inferrer A3, and request re-training or instruct switching of the models based on the evaluation results.

The model recorder A6 functions as a reference point in the functional blocks. Therefore, the model recorder A6 does not necessarily have to record the trained model or the updated model in the recording media.

Note that how the functional blocks illustrated in FIG. 15 are arranged in each use case is under discussion in the 3GPP.

In the following, the AI/ML model to be trained may be referred to as a “training model” and the AI/ML model after training may be referred to as a “trained model”. Data for inference may be referred to as inference data, and data for training may be referred to as training data. When the AI/ML model in the middle of model training and the trained AI/ML model are not distinguished from each other, they may be simply referred to as AI/ML models. The “AI/ML model” is, for example, a data-driven algorithm to which an AI/ML technology is used to obtain a series of outputs based on a series of inputs, as described above.

### Communication Control Method According to First Embodiment

A communication control method according to the first embodiment will be described.

Currently, the 3GPP has discussed transfer (or delivery) of the AI/ML model. In particular, an agreement has been made on reactive model transfer/delivery (which may be referred to as a “reactive model transfer” in the following). The reactive model transfer refers to a technique of downloading an AI/ML model when the model is needed due to a scenario, a configuration, or a change of location. For example, the UE 100 performs a handover (i.e., change of location) to the target cell and receives a new AI/ML model from the target cell when the AI/ML model is not available in the target cell. Such a case is expected to corresponds to the reactive model transfer.

In the 3GPP, in addition to the reactive model transfer, a proactive model transfer/delivery (which may be referred to as a “proactive model transfer” below) will be discussed. The proactive model transfer refers to a technique in which, for example, an AI/ML model is downloaded in advance, and model switching is performed when a change occurs in a scenario, a configuration, or a location. For example, the technique includes pre-downloading, by the UE 100, an AI/ML model from a serving cell, and after handover to the target cell, switching to the downloaded AI/ML model (from the previously used AI/ML model). The proactive model transfer allows immediate use of the (pre-downloaded) AI/ML model, for example, since the UE 100 has no need to wait for the AI/ML model to be downloaded after a change in location.

In the first embodiment, attention is paid to the proactive model transfer. For example, even when the AI/ML model is transferred to the UE 100 due to the proactive model transfer, the AI/ML model may be deleted in the UE 100 due to the memory capacity. Thereafter, for example, when the UE 100 switches the connection from the serving cell to the target cell through the handover and receives the AI/ML model from the target cell, the proactive model transfer itself by the serving cell may be wasted.

The first embodiment aims to keep the UE 100 from deleting the AI/ML model.

For this reason, in the first embodiment, when the network apparatus transmits to the UE 100 the AI/ML model to the UE 100 through a proactive model transfer, the network apparatus transmits deletion prohibition information indicating that the AI/ML model is not allowed to be deleted.

Specifically, first, the network apparatus transmits to the user equipment an AI/ML model available under a predetermined condition and deletion prohibition information indicating that the AI/ML model is not allowed to be deleted (for example, the UE 100) before the predetermined condition occurs. Second, the user equipment uses the AI/ML model under the predetermined condition without deleting the AI/ML model according to the deletion prohibition information. Here, the predetermined condition may be any one of a condition that congestion has occurred on a communication path between the user equipment and the network apparatus, a condition that the user equipment has made an emergency call, and a condition that the user equipment has received a message about a public warning system (PWS).

As described above, in the first embodiment, since the network apparatus transmits the AI/ML model and the deletion prohibition information to the UE 100 before the occurrence of congestion, the UE 100 can appropriately receive the AI/ML model and can keep the AI/ML model from being deleted according to the deletion prohibition information.

In the first embodiment, a case where congestion occurs will be described as an example of the predetermined condition. As the predetermined condition, the case where the UE 100 makes an emergency call and the case where the UE 100 receives a message related to a public warning system (PWS) will be described in a second embodiment.

### Operation Example According to First Embodiment

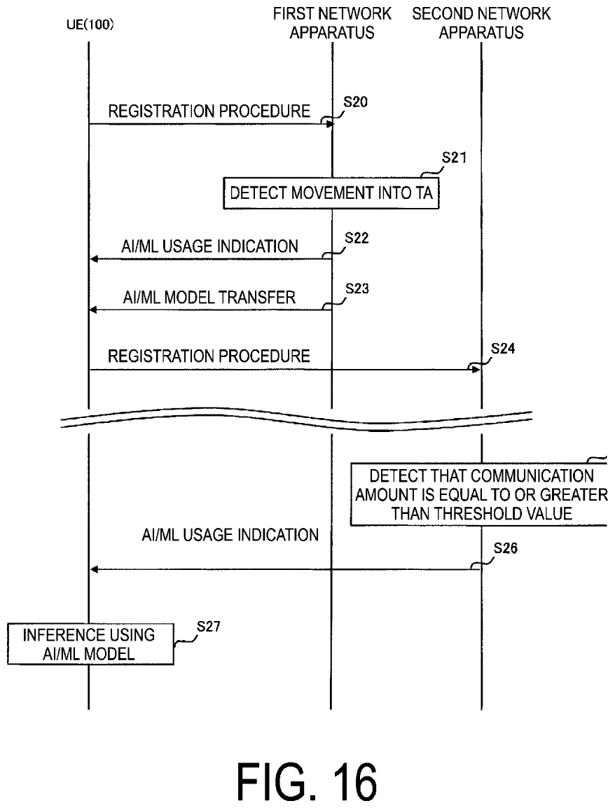

FIG. 16 is a diagram illustrating an operation example according to the first embodiment. In the operation example illustrated in FIG. 16, a case where congestion occurs in a fireworks venue will be described as an example.

Here, there exists a tracking area (TA) including the fireworks venue, and there exists an AMF that manages the tracking area. In FIG. 16, the AMF (second AMF) is illustrated as an example of a second network apparatus. Meanwhile, there exists also a tracking area adjacent to the tracking area (TA) including the fireworks venue, and there exists also an AMF that manages the tracking area. In FIG. 16, the AMF (first AMF) is illustrated as an example of a first network apparatus. That is, FIG. 16 illustrates an example in which a fireworks venue is located in a TA managed by the second network apparatus and the first network apparatus manages a TA adjacent to the TA.

In step S20, the UE 100 performs a registration procedure with the first network apparatus. The UE 100 performs registration with the network under control of the first network apparatus through a registration procedure.

In step S21, the first network apparatus detects that the UE 100 is moving to a predetermined TA (e.g., a TA including the fireworks venue). For example, when the first network apparatus is an AMF, the controller of the AMF may detect the movement based on the identifier “last visited TAI” of the TA that the UE visited last, the identifier being received from the UE 100, during the registration procedure. Specifically, if the identifier is one other than the tracking area identifier (TAI) managed by the second network apparatus, the controller may detect that the UE 100 is moving to the TA managed by the second network apparatus, that is, the TA of the fireworks venue (or is heading toward the TA).

In step S22, when the first network apparatus detects that the UE 100 is moving to a predetermined TA, the first network apparatus transmits a usage indication for the trained AI/ML model to the UE 100. For example, when the first network apparatus is an AMF, a transmitter of the AMF transmits a NAS message including the usage indication to the UE 100.

First, for a UE-sided model, the first network apparatus checks whether the UE 100 holds the AI/ML model targeted for the usage indication. The UE-sided model is, for example, a model in which the UE 100 performs inference using a trained AI/ML model. On the other hand, a model in which the network apparatus performs inference using the trained AI/ML model may be referred to as a network-sided model. For example, the transmitter 120 of the UE 100 may transmit a NAS message including identification information (or a model ID) of the trained AI/ML model held by the UE to the first network apparatus (AMF) during the registration procedure. The controller of the first network apparatus checks whether the UE 100 holds the trained AI/ML model targeted for the usage indication based on the identification information.

If the first network apparatus confirms that the UE 100 does not hold the trained AI/ML model targeted for the usage indication, the first network apparatus transmits the trained AI/ML model to the UE 100 (that is, performs “model transfer”) in step S23. The transmitter of the AMF 300, for example, transmits a NAS message including the trained AI/ML model to the UE 100.

As described above, in the first embodiment, “model transfer” of the trained AI/ML model is performed before congestion occurs. The “model transfer” can be considered to correspond to the “proactive model transfer” described above.

In the first embodiment, when transmitting the trained AI/ML model to the UE 100, the first network apparatus transmits, to the UE 100, deletion prohibition information indicating that the trained AI/ML model is not allowed to be deleted. The deletion prohibition information may be transmitted together with the usage indication for the AI/ML model (step S22). The deletion prohibition information may be transmitted together with the AI/ML model (step S23). The deletion prohibition information may be transmitted after the AI/ML model is transferred. The transmitter of the AMF 300, for example, may transmit a NAS message including the deletion prohibition information to the UE 100. The UE 100 receives the deletion prohibition information. The receiver 110 of the UE 100 may receive the NAS message including the deletion prohibition information.

Note that when the UE 100 receives the deletion prohibition information, the UE 100 may transmit, to the network apparatus, information indicating that not allowing the trained AI/ML model to be deleted cannot be performed (that is, the trained AI/ML model needs to be deleted) because the memory capacity of the UE 100 itself is limited. Alternatively, when the trained AI/ML model needs to be deleted after the UE 100 receives the deletion prohibition information, the UE 100 may transmit request information for requesting deletion of the trained AI/ML model to the network apparatus. On the other hand, the network apparatus may transmit, to the UE 100, a deletion condition (for example, insufficient memory capacity) for deleting the trained AI/ML model, together with the deletion prohibition information. Alternatively, the network apparatus may transmit a priority number related to deletion prohibition to the UE 100 when transferring the trained AI/ML model. The priority number indicates that, for example, the higher the priority number, the more the deletion prohibition of the trained AI/ML model is prioritized, and the lower the priority number, the more likely the trained AI/ML model is permitted to be deleted (or the priority number may be reversed). The priority number may be transmitted together with the transfer of the trained AI/ML model. The priority number may be included in the deletion prohibition information and transmitted.

The deletion prohibition information may be represented as flag information indicating that the trained AI/ML model is not allowed to be deleted. Alternatively, the deletion prohibition information may include information indicating that the trained AI/ML model is not allowed to be deleted until a specified deadline. This is because congestion is likely to occur until the specified deadline and the trained AI/ML model is kept from being deleted until the specified deadline. Alternatively, the deletion prohibition information may include the specified deadline. Since the deletion prohibition information includes the specified deadline, the deletion prohibition information may indicate that the trained AI/ML model is not allowed to be deleted until the specified deadline. Alternatively, the deletion prohibition information may include the reason that the trained AI/ML model is not to be deleted. The reason may be, for example, the possibility of congestion that may occur in the fireworks venue. Alternatively, the deletion prohibition information may include identification information (for example, a model ID) of the trained AI/ML model which is not allowed to be deleted. The transmitter of the AMF 300, for example, may transmit a NAS message including the deletion prohibition information to the UE 100. The UE 100 receives the deletion prohibition information. The receiver 110 of the UE 100 receives the deletion prohibition information, for example. When the UE 100 (the controller 130 thereof) receives the deletion prohibition information, the UE holds the target trained AI/ML model in a memory or the like without deleting the trained AI/ML model. When the deletion prohibition information includes the specified deadline, the UE 100 holds the target trained AI/ML model until the specified deadline arrives. When the deletion prohibition information includes the identification information of the target trained AI/ML model, the UE 100 holds the trained AI/ML model. Alternatively, the deletion prohibition information may include position information indicating a position where not allowing the trained AI/ML model to be deleted is not performed. For example, since there exists a network apparatus in which no machine-learning technique using the AI/ML model is performed depending on network apparatuses, the UE 100 may be notified of such a network apparatus so that the UE 100 can avoid a connection to the network apparatus, avoiding a situation in which no trained AI/ML model is transferred from the network apparatus. The position information may be indicated by, for example, a TAID. The position information may be indicated by a cell ID. The position information may be indicated by GNSS position information. Designation of the position information may indicate that not allowing the trained AI/ML model to be deleted is not performed when the user moves to the position. The designation may indicate that not allowing the trained AI/ML model to be deleted is not performed when the user moves to the outside from the position.

Second, in the case of a network-sided model, the first network apparatus indicates collection of inference data and transmission of the data for inference to the network apparatus (Data Collection) as a usage indication for the trained AI/ML model (step S22).

Note that, in the network-sided model, the UE 100 may hold a target trained AI/ML model. In this case, the first network apparatus may indicate to the UE 100 to transfer the trained AI/ML model together with the usage indication for the trained AI/ML model (step S22). The first network apparatus may transmit, to the UE 100, the deletion prohibition information for the indicated trained AI/ML model. The transmitter of the network apparatus transmits a message including the indication for transfer and deletion prohibition information of the trained AI/ML model to the UE 100. In response to the reception of the message by the receiver 110 of the UE 100, the controller 130 of the UE 100 does not delete the indicated trained AI/ML model, and the transmitter 120 of the UE 100 transmits the trained AI/ML model (a message including the trained AI/ML model) to the network apparatus. In this case, a “model transfer” of the trained model is performed as well before congestion occurs. The “model transfer” can be considered to correspond to a “proactive model transfer”. Both the message transmitted by the network apparatus and the message transmitted by the UE 100 may be NAS messages.

In step S24, upon continuing to move and entering a TA managed by the second network apparatus, the UE 100 performs a registration procedure with the second network apparatus (AMF). The UE 100 is registered in a network of the AMF having a predetermined TA (for example, a TA having a fireworks venue) under the control thereof.

In step S25, the second network apparatus detects that the communication amount in the data communication path of the UE 100 is equal to or greater than a threshold value. The data communication path may be a communication path between the UE 100 and a UPF (e.g., a UPF that processes data transmitted from the UE 100 in the fireworks venue). That is, the controller of the second network apparatus detects that congestion has occurred in the data communication path. In the fireworks venue, congestion is occurring.

In step S26, the second network apparatus transmits a usage indication for the trained AI/ML model to the UE 100. For example, the transmitter of the second network apparatus transmits a NAS message including the usage indication to the UE 100. The UE 100 receives the usage indication. The usage indication may be transmitted before the occurrence of the congestion (step S25).

In the case of a UE-sided model, in step S27, the UE 100 performs inference using the trained AI/ML model received in step S23 according to the usage indication. In the case of the network-sided model, the UE 100 collects inference data for the trained AI/ML model used in the second network apparatus and transmits the collected inference data to the second network apparatus, instead of performing step S27. The inference data may be transmitted via a NAS message.

### Another Operation Example 1 According to First Embodiment

Although the example in which a network apparatus is an AMF has been mainly described in the first embodiment, a network apparatus is not limited to an AMF. The network apparatus may be a gNB 200.

First, in FIG. 16, the first network apparatus may be a “first cell” and the second network apparatus may be a “second cell”. The first cell and the second cell may be managed by the same gNB, or different gNBs may manage the cells, respectively.

Second, instead of the registration procedure (step S20 and step S24), a handover procedure may be used. The handover procedure in step S20 is a procedure for the UE 100 to perform a handover from another cell to the first cell. The handover procedure in step S24 is a procedure for the UE 100 to perform a handover from the first cell to the second cell. In this case, although the first cell indicates to the UE 100 to perform a handover using an RRC message (for example, an RRC reconfiguration (RRCReconfiguration) message, the first cell may include the deletion prohibition information in the RRC message and transmit the RRC message to the UE 100.

Third, in the first embodiment, the NAS message may be rephrased as an RRC message. The usage indication for the trained AI/ML model in step S22 and step S26 may be included and transmitted in the RRC message. The transfer of the AI/ML model of step S23 may also be performed by being included and transmitted in the RRC message (or the above-described configuration message). The deletion prohibition information may be included and transmitted in the RRC message. The RRC message may be transmitted between the transmitter 120 of the UE 100 and the receiver 220 of the gNB 200, or may be transmitted between the transmitter 210 of the gNB 200 and the receiver 110 of the UE 100. The processing by the first network apparatus (step S21) and the processing by the second network apparatus (step S25) may be performed by the controller of the gNB 200.

Note that, although the example in which the predetermined condition is the occurrence of congestion has been described as an example in the first embodiment, the predetermined condition is not limited thereto. For example, completion of a handover described above may be set as the predetermined condition. To be more specific, for example, in the first embodiment, instead of the congestion-related operation (step S25), the predetermined condition may be set to transmission of a handover complete message (for example, an RRCReconfigurationComplete message) from the second cell. The handover complete message may include the usage indication.

### Another Operation Example 2 According to First Embodiment

In the other operation example 1 according to the first embodiment, the “first cell” may be a first gNB, and the “second cell” may be a second gNB. This case is an example in which a network apparatus is a gNB.

### Another Operation Example 3 According to First Embodiment

In the first embodiment, the example in which the trained AI/ML model is transmitted to the UE 100 in the proactive model transfer has been described. For example, the transfer of the trained AI/ML model may be performed in a reactive model transfer. For example, the first network apparatus does not transfer the trained AI/ML model (step S23), and the second network apparatus transfers the trained AI/ML model from step S25 and thereafter. In this case, the target of the deletion prohibition information is the trained AI/ML model transferred by the second network apparatus. The reactive model transfer may be performed, for example, under a condition other than congestion among predetermined conditions.

### Another Operation Example 4 According to First Embodiment

In the other operation example 3 described above, the example in which the predetermined conditions include handover has been described. For example, instead of the occurrence of congestion, a condition that the UE 100 flows into a specific TA may be used as the predetermined condition. In this case, in FIG. 16, the operation related to congestion (step S25) is not performed. The following processing may be performed, instead of step S25. That is, the UE 100 that has performed tracking area update (TAU) from a TA #1 to a TA #2 and performed the registration procedure (step S24) with respect to the second network apparatus (for example, AMF #2) that manages the TA #2 receives an SIB broadcast from the gNB 200 in the TA #2. The SIB includes identification information of the TA #2. When the UE 100 confirms that the UE is located in the TA #2 based on the SIB, the UE performs inference using the AI/ML model (for the TA #2) without receiving a usage indication in step S26 (step S27). Alternatively, the UE 100 receives the usage indication from the second network apparatus after performing step S24, instead of receiving the SIB (step S26). Accordingly, the UE 100 can perform inference using the AI/ML model (for the TA #2) similarly to when the UE receives an SIB (step S27).

Other Operation Example 5 According to First Embodiment

In the first embodiment, the example of the AMF has been described as an example of the first network apparatus and the second network apparatus. In the other operation example 1 according to the first embodiment, a cell (or gNB) has been described as an example of the first network apparatus and the second network apparatus. The first network apparatus and the second network apparatus may be collectively regarded as an OTT server. In this case, the OTT server and the UE 100, for example, perform the following processing.

That is, the UE 100 transmits position information acquired by the GNSS receiver 150 to the OTT server, for example, at regular time intervals. The OTT server detects that UE 100 is approaching the fireworks venue based on the position information. At this time, the OTT server transmits deletion prohibition information and the trained AI/ML model to the UE 100. The OTT server also transmits the position information of the fireworks venue to the UE 100.

The UE 100 detects that the UE itself has arrived at the fireworks venue based on the position information acquired by the GNSS receiver 150 and the position information of the fireworks venue acquired from the OTT server. At this time, the UE 100 performs inference using the trained AI/ML model (used in the fireworks venue) received from the OTT server.

### Other Operation Example 6 According to First Embodiment

An example of the network apparatus may be an LMF. The LMF 300 is an example of a core network apparatus. In this case, for example, the following operation is performed.

That is, the UE 100 acquires position information via the LMF. The LMF detects that the UE 100 is approaching the fireworks venue from the position information of the UE 100. At this time, the LMF transmits the trained AI/ML model and deletion prohibition information to the UE 100. The LMF also transmits the position information of the fireworks venue to the UE 100.

The UE 100 may acquire the position information of its own from the LMF at regular time intervals. The UE detects that the UE itself has moved to the fireworks venue based on the position information acquired from the LMF and the position information of the fireworks venue received from the LMF. At this time, the UE 100 performs inference using the trained AI/ML model (used in the fireworks venue) received from the LMF. In this way, a core network apparatus such as the LMF may be used as the network apparatus used in the first embodiment.

### Second Embodiment

A second embodiment will be described. The first embodiment has described congestion as an example of the predetermined condition. In the second embodiment, examples of the predetermined condition include a case where the UE 100 makes (or originates) an emergency call and a case where the UE 100 receives a message related to a public warning system (PWS).

In the second embodiment, an example will be described in which a trained AI/ML model used in a more highly urgent situation than in other systems, such as an emergency call and PWS, is transferred from a network apparatus to the UE 100 before a highly urgent situation takes place (that is, proactive model transfer). In the second embodiment, an example in which deletion prohibition information is transferred from a network apparatus to the UE 100 when the proactive model transfer of the trained AI/ML model is performed as in the first embodiment will be described.

Note that, although a message related to the PWS will be described exemplifying an Earthquake and Tsunami Warning System (ETWS) or a Commercial Mobile Alert System (CMAS) in the second embodiment, the message is not limited thereto, and may be another message related to the PWS. The ETWS is a system for distributing information having high urgency, such as information of tsunami and earthquakes, to the UE 100. The CMAS is a system for distributing a wide range of information, such as presidential messages and advertisements of products, to the UE 100.

### Operation Example According to Second Embodiment

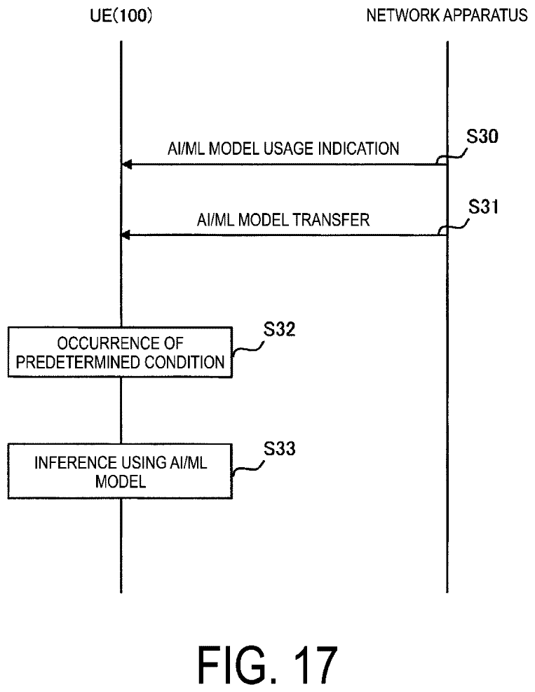

FIG. 17 is a diagram illustrating an operation example according to the second embodiment. The network apparatus may be an AMF, a gNB 200, or another core network apparatus. The network apparatus may be an over-the-top (OTT) server.

In step S30, the network apparatus transmits a usage indication for the trained AI/ML model to the UE 100. The usage indication represents an indication to use the trained AI/ML model provided that a predetermined condition has occurred in the UE 100.

First, the predetermined condition may be that the UE 100 has made (or originated) an emergency call. An emergency call is alerting, by the UE 100, police stations, hospitals, fire stations, and other national emergency organizations. For example, when the controller 130 of the UE 100 detects that the UE 100 has made (or originated) a call to a number addressed to such an organization, that the predetermined condition has occurred is detected.

Second, the predetermined condition may be the UE 100 having received either a message related to the ETWS or a message related to the CMAS. To be more specific, the predetermined condition may be determined to have occurred when the receiver 110 of the UE 100 receives broadcast information indicating a message related to the ETWS (for example, SIB6 and/or SIB7). Alternatively, the predetermined condition may be determined to have occurred when the receiver 110 of the UE 100 receives broadcast information (for example, SIB8) indicating a message related to the CMAS.

Third, the predetermined condition may be that the UE 100 has detected the occurrence of congestion. For example, the controller 130 of the UE 100 may detect that congestion has occurred when the transmitter 120 of the UE 100 repeats retransmission a predetermined number of times or more within a predetermined time.

If the network apparatus is a gNB, the transmitter 210 of the gNB 200 may transmit, to the UE 100, an RRC message including the usage indication. If the network apparatus is an AMF, the transmitter of the AMF 300 may transmit a NAS message including the usage indication. If the network apparatus is an OTT server, the transmitter of the OTT server may transmit a message of a predetermined protocol including the usage indication. The UE 100 receives the usage indication. The receiver 110 of the UE 100, for example, receives a message including the usage indication.

In step S31, the network apparatus transmits the trained AI/ML model to the UE 100. The trained AI/ML model is a trained AI/ML model available under the predetermined condition. The trained AI/ML model may be a trained AI/ML model used by the UE 100 in an emergency. The trained AI/ML model is transmitted before occurrence of the predetermined condition, and thus corresponds to a “proactive model transfer”. For example, the transmitter of the network apparatus transmits a message including the trained AI/ML model to the UE 100. The message may be any of an RRC message (or a configuration message), a NAS message, and a message of a predetermined protocol, depending on the type of the network apparatus. The UE 100 receives the trained AI/ML model. For example, the receiver 110 of the UE 100 receives a message including the trained model.

In the second embodiment, the network apparatus transmits deletion prohibition information for the trained AI/ML model, as in the first embodiment. The deletion prohibition information may be transmitted together with a usage indication for the trained AI/ML model (step S30). The deletion prohibition information may be transmitted together with the trained AI/ML model (step S31). The deletion prohibition information may be transmitted after the trained AI/ML model is transmitted. The transmitter of the network apparatus may transmit a message including the deletion prohibition information. The message may be an RRC message depending on the type of the network apparatus. The message may be a NAS message. The message may be a message according to a predetermined protocol. The deletion prohibition information may have the same content as in the first embodiment. When the UE 100 (the controller 130 thereof) receives the deletion prohibition information, the UE 100 uses the trained AI/ML model upon occurrence of the predetermined condition, without deleting the trained AI/ML model.

Note that step S31 represents an example of the UE-sided model. In the case of the network-sided model, when the network apparatus does not hold a trained model to be used in emergencies, the UE 100 may transmit the trained AI/ML model to the network apparatus, instead of performing step S31. In this case, for example, the usage indication in step S30 includes identification information (or a model ID) of the trained model to be used in emergencies. The UE 100 may transmit the trained model corresponding to the identification information to the network apparatus. In this case, the usage indication and the trained model are also included and transmitted in the RRC message (or the configuration message), the NAS message, and the message according to the predetermined protocol according to the type of the network apparatus.

In step S32, the UE 100 detects that the predetermined condition has occurred. For example, the occurrence of the predetermined condition is detected in the following cases. That is, the predetermined condition having occurred is detected when the controller 130 of the UE 100 detects that a call to the emergency organization has been made. The predetermined condition having occurred is detected when the receiver 110 of the UE 100 receives SIB6 and/or SIB7. The predetermined condition having occurred is detected when the receiver 110 of the UE 100 receives SIB8. The controller 130 of the UE 100 may detect that the predetermined condition has occurred when the transmitter 120 of the UE 100 repeats retransmission a predetermined number of times or more within a predetermined time, assuming that congestion has occurred.

In the case of the UE-sided model, in step S33, the UE 100 performs inference using the trained AI/ML model received in step S31. In the case of the network-sided model, the UE 100 collects inference data to be used in the network apparatus and transmits the collected inference data to the network apparatus, instead of performing step S33. The inference data may also be transmitted using any of an RRC message (or control data), a NAS message, and a message of a predetermined protocol, depending on the type of the network apparatus.

Note that the network apparatus may transmit, to the UE 100, a usage indication for the trained AI/ML model transmitted in step S31, triggered by the detection of the occurrence of the predetermined condition. For example, the transmitter of the network apparatus may transmit a message including the usage indication to the UE 100 in response to the receiver of the network apparatus receiving an emergency call. The transmitter 210 of the gNB 200 may transmit an RRC message including the usage indication to the UE 100 simultaneously with broadcasting of SIB6 and/or SIB7. The transmitter 210 of the gNB 200 may transmit the RRC message including the usage indication simultaneously with broadcasting of SIB8. The UE 100 (receiver 110 thereof) receives the message. The UE 100 may perform step S33 in response to reception of the usage indication.

### Another Operation Example 1 According to Second Embodiment

In the second embodiment, the trained AI/ML model used in emergencies has been described on the premise that the UE 100 does not hold the trained AI/ML model in the network apparatus. For example, when the network apparatus confirms that the UE 100 does not hold an AI/ML model, the network apparatus may transmit an AI/ML model to the UE 100. For example, the following processing may be performed. That is, the transmitter of the network apparatus transmits a confirmation message indicating whether or not an AI/ML model is held to the UE 100. The confirmation message may include identification information of the AI/ML model. In response to reception of the confirmation message, the transmitter 120 of the UE 100 transmits a response message including the confirmation result indicating whether an AI/ML model is held to the network apparatus. The transmitter of the network apparatus transmits a trained AI/ML model to be used in emergencies to the UE 100 in response to the confirmation result. The confirmation message and the response message may be any of an RRC message, a NAS message, and a message of a predetermined protocol, depending on the type of the network apparatus.

### Other Embodiments

In the first and second embodiments, the predetermined condition has been described by exemplifying any of a congestion having occurred on the communication path between the user equipment and the network apparatus, the user equipment transmitting an emergency call, and the user equipment having received a message about the public warning system (PWS). The predetermined condition may be, for example, a handover to a specific cell or entry into a specific TA (or execution of a registration procedure with respect to a specific TA).

In the first and second embodiments, the UE-sided model has been mainly described. The first and second embodiments are also applicable to a two-sided model. The two-sided model is, for example, a model in which inference using a trained AI/ML model is performed in both the UE 100 and the network apparatus. The two-sided model is, for example, as described below.

That is, the UE 100 uses the trained AI/ML model to infer (or output) a punctured CSI-RS as inference data and (punctured) CSI as inference result data. The UE 100 transmits the CSI to the network apparatus. The network apparatus infers the (punctured) CSI as inference data and infers the CSI obtained using all CSI-RSs (that is, unpunctured CSI) as inference result data.

Even in the case of two-sided models, the first network apparatus transfers the trained AI/ML model (step S23), as in the first embodiment. In this case, the network apparatus transmits, as a transfer target, the trained AI/ML model used in the UE 100, among two-sided models, to the UE 100. As described above, even in the case of the two-sided model, the present embodiment can be implemented as in the first embodiment (FIG. 16). Also in the second embodiment, in the transfer of the trained AI/ML model in step S31, the trained AI/ML model used in the UE 100 among the two-sided models is the transfer target.

In the first and second embodiments, the example in which deletion prohibition information is used has been described. For example, the network apparatus may transmit deletion permission information indicating that the trained AI/ML model may be deleted to the UE 100, instead of the deletion prohibition information. The deletion permission information may include the model ID (or the model ID in a list format) of the trained AI/ML model to be deleted. The deletion permission information may include priority (for each trained AI/ML model as a target). In this case, the higher the priority number, the more likely the AI/ML model is to be deleted, and the lower the priority number, the less likely the AI/ML model is to be deleted (or vice versa).

In the first and second embodiments described above, supervised learning has mainly been described, but the present disclosure is not limited thereto. For example, the first embodiment may be applied to unsupervised learning or reinforcement learning.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each processing operation performed by the UE 100, the gNB 200, or the network apparatus may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing each processing operation performed by the UE 100, the gNB 200, or the network apparatus may be integrated, and at least some of the UE 100, the gNB 200, or the network apparatus may be configured as a semiconductor integrated circuit (chipset or System-on-a-Chip (SoC)).

The functions achieved by the UE 100, the gNB 200, or the network apparatus may be implemented in a circuitry or a processing circuitry programmed to achieve the described functions, including a general-purpose processor, a special-purpose processor, an integrated circuit, application specific integrated circuits (ASICs), a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. The embodiments, the operation examples, or the different types of processing may be combined as appropriate as long as they are not inconsistent with each other.

### Supplementary Notes

### Supplementary Note 1

A communication control method in a mobile communication system, the communication control method including:
transmitting, by a network apparatus to a user equipment, an AI/ML model available under a predetermined condition and deletion prohibition information indicating that the AI/ML model is not allowed to be deleted, before the predetermined condition occurs; and
using, by the user equipment, the AI/ML model under the predetermined condition without deleting the AI/ML model according to the deletion prohibition information,
in which the predetermined condition is any of congestion having occurred on a data communication path of the user equipment, the user equipment transmitting an emergency call, and the user equipment having received a message about a public warning system (PWS).

### Supplementary Note 2

The communication control method described in supplementary note 1, in which the deletion prohibition information includes at least any of not allowing the AI/ML model to be deleted until a designated deadline, the designated deadline, and the reason for not allowing the AI/ML model to be deleted.

### Supplementary Note 3

A network apparatus in a mobile communication system, including:
a transmitter configured to transmit to a user equipment an AI/ML model available under a predetermined condition and deletion prohibition information indicating that the AI/ML model is not allowed to be deleted before the predetermined condition occurs,
in which the predetermined condition is any of congestion having occurred on a data communication path of the user equipment, the user equipment transmitting an emergency call, and the user equipment having received a message about a public warning system (PWS).

### REFERENCE SIGNS

1: Mobile communication system
20: 5GC (CN)
100: UE
110: Receiver
120: Transmitter
130: Controller
200: gNB
210: Transmitter
220: Receiver
230: Controller
300: AMF

1. A communication control method in a mobile communication system, the communication control method comprising:
transmitting, by a network apparatus to a user equipment, an artificial intelligence/machine learning (AI/ML) model available under a predetermined condition and deletion prohibition information indicating that the AI/ML model is not allowed to be deleted, before the predetermined condition occurs; and
using, by the user equipment, the AI/ML model under the predetermined condition without deleting the AI/ML model according to the deletion prohibition information,
wherein the predetermined condition is any of congestion having occurred on a data communication path of the user equipment, the user equipment transmitting an emergency call, and the user equipment having received a message about a public warning system (PWS).

2. The communication control method according to claim 1, wherein the deletion prohibition information comprises at least any of not allowing the AI/ML model to be deleted until a designated deadline, the designated deadline, and the reason for not allowing the AI/ML model to be deleted.

3. A network apparatus in a mobile communication system, the network apparatus comprising:
a transmitter configured to transmit to a user equipment an AI/ML model available under a predetermined condition and deletion prohibition information indicating that the AI/ML model is not allowed to be deleted, before the predetermined condition occurs,
wherein the predetermined condition is any of congestion having occurred on a data communication path of the user equipment, the user equipment transmitting an emergency call, and the user equipment having received a message about a public warning system (PWS).
